(19) United States
(12) Patent Application Publication
(10) Pub. No.: US 2026/0267681 A1
(43) Pub. Date: Sep. 10, 2026

(54) HIERARCHICAL ALLOCATION OF TRANSACTION IDENTIFIERS

(71) Applicant: Infineon Technologies AG, Neubiberg (DE)

(72) Inventor: Frank Hellwig, Wunstorf (DE)

(21) Appl. No.: 19/070,588

(22) Filed: Mar. 5, 2025

(51) Int. Cl. G06F 9/48; G06F 9/455; G06F 9/46

(52) U.S. Cl. CPC G06F 9/4818; G06F 9/45554; G06F 9/466

(57) ABSTRACT

Systems, methods, and circuitries, are provided for hierarchically allocating transaction identifiers (TIDs) in a controller. In one example, TID allocation circuitry is configured to process TID locking commands from one or more priority entities. The locking commands disable TIDs in a first set of TIDs and a disabled status of the TIDs of the first set of TIDs is locked until a next controller reset. The TID allocation circuitry is configured to then process TID enablement/disablement commands from one or more application entities, wherein each application entity is associated with an initiator. The enablement/disablement commands enable or disable one or more TIDs for use by the associated initiator subject to the constraint that the TIDs in the first set of TIDs cannot be enabled for use by an enablement command.

### FIELD

The present disclosure relates generally to the field of processors and central processing units (CPUs) and more particularly to an access control system for a processing system that includes one or more initiators that share access to one or more target modules.

### BACKGROUND

Modern microcontroller units (MCUs) include system on chip (SoC) architectures in which an interconnect structure controls access to shared resources by one or more initiators such as central processing units (CPUs), processing cores, virtual machines, and so on.

### BRIEF DESCRIPTION OF THE DRAWINGS

Some examples of circuits, apparatuses and/or methods will be described in the following by way of example only. In this context, reference will be made to the accompanying Figures.

FIG. 1 is a diagram illustrating an example hierarchy of isolation requirements for multiple applications in execution on an MCU, in accordance with various aspects described.

FIGS. 2A and 2B are a block diagrams of an example MCU architecture that includes transaction identifier (TID) assignment circuitry and TID assignment register (TAR) configuration circuitry, in accordance with various aspects described.

FIG. 3 is a block diagram illustrating an example processing of transactions using TIDs, in accordance with various aspects described.

FIG. 4 is a block diagram illustrating an example TAR configuration circuitry, in accordance with various aspects described.

FIG. 5 is a block diagram illustrating an example TAR configuration circuitry, in accordance with various aspects described.

FIG. 6 is a block diagram illustrating an example TAR configuration circuitry, in accordance with various aspects described.

### DETAILED DESCRIPTION

The present disclosure is described with reference to the attached figures. Similar components in various figures may be represented by similar reference characters. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

Multicore microcontroller units (MCUs) may execute multiple independent software applications simultaneously and often software isolation between the applications is desirable. The access protection mechanisms used by an MCU may be required to meet Automotive Safety Integrity Level D (ASILD) for applications with ASILD targets and security requirements for applications with security targets. Multiple applications with different safety and security targets, (e.g., ASILD, Security, QM, and so on) may be referred to herein as applications with mixed criticality.

Each application in execution on an MCU uses a subset of the MCU's on-chip resources such as a CPU (e.g., core, virtual machine) for software execution, memory, direct memory access (DMA), and so on. Different applications may have different requirements regarding the allocation of on-chip resources as between applications as well as the allocation of on-chip resources to different sub-tasks associated with each individual application. Amidst the sharing of hardware resources, it is desirable or even required that different applications be isolated from one another. In some instances, different tasks or functions of the same application should be isolated from one another. In a general sense, isolation between two application tasks or functions means that each of the application tasks may be assigned its own individual access privilege level to shared resources (also called target modules herein). The access privilege level may be, for example, a level of read and/or write access to a certain portion or function of a target module. In this manner shared resources designated for use by a certain application task may be protected from access by unauthorized application tasks.

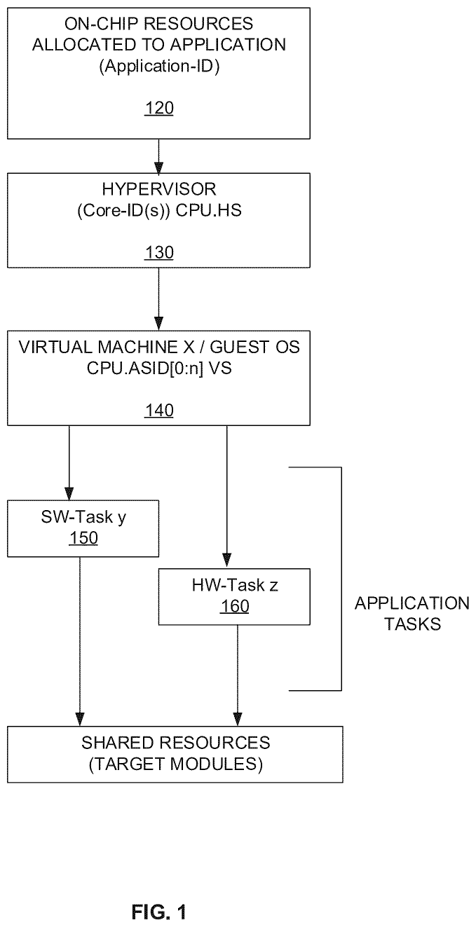

FIG. 1 illustrates the hierarchical nature of isolation requirements in a multi-application environment. Block 120 indicates a set of on-chip resources assigned to a single application, identified by an Application ID. Different sets of on-chip resources are assigned to multiple other applications (not shown) to provide isolation between the applications. The application includes one or more hypervisors at hypervisor level 130. Each hypervisor controls one or more physical cores, each of which is identified by a core-ID or CPU. HS indicator. Each hypervisor controls multiple virtual machines (level 140). Each virtual machine may be identified by CPU.VMID[0:m] where VMID may be identified by a virtual machine ID or VS indicator. Each VM may have its own ASIL-related isolation requirement.

Each VM includes a Guest OS that performs multiple software tasks 150 and hardware tasks 160, with each task 150, 160 corresponding to a particular application sub-task. The software tasks may be identified by CPU. MSID[0:m] or CPU. ASID[0:m] if a hypervisor is not used. Here ASID means address space identifier. Each software and hardware task may have its own ASIL-related isolation requirement. An example of an ASILD hardware task that may be assigned to a software task is a DMA with hardware ASILD protection through lockstep or functional redundancy support. Non-ASILD hardware tasks that may be assigned to software tasks include DMA without functional redundancy, CAN XL DMA channels, GETH/LETH DMA channels, PCIe, and so on. It can be seen that applications with mixed criticality present a challenge to providing proper isolation.

To provide isolation between applications, transaction identifiers (IDs) may be included with transactions provided by an initiator to an interconnect that seek access to a target module. Each transaction ID is mapped a specific application 120 and software task 150 or hardware task 160. The transaction IDs are mapped, at the target modules, to specific types of access.

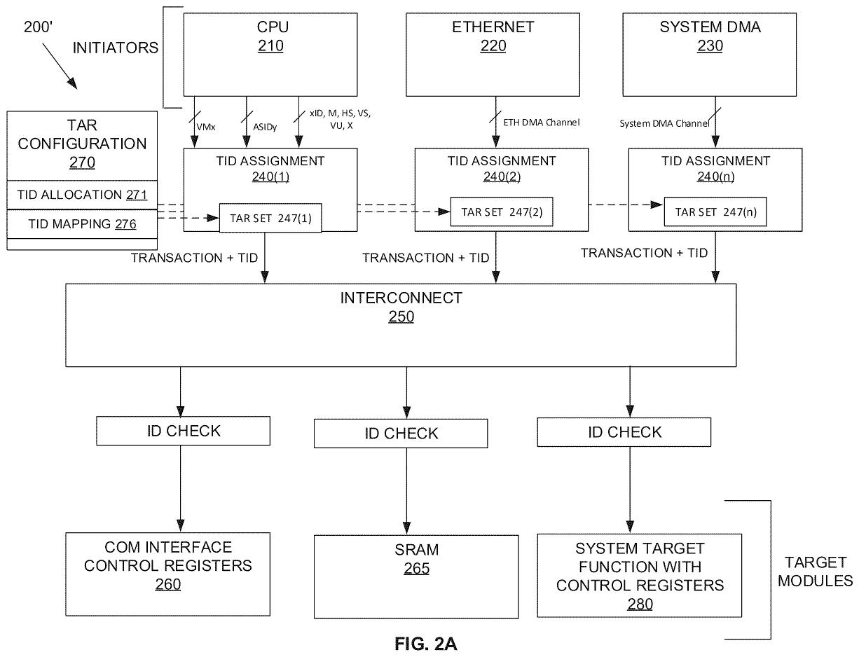

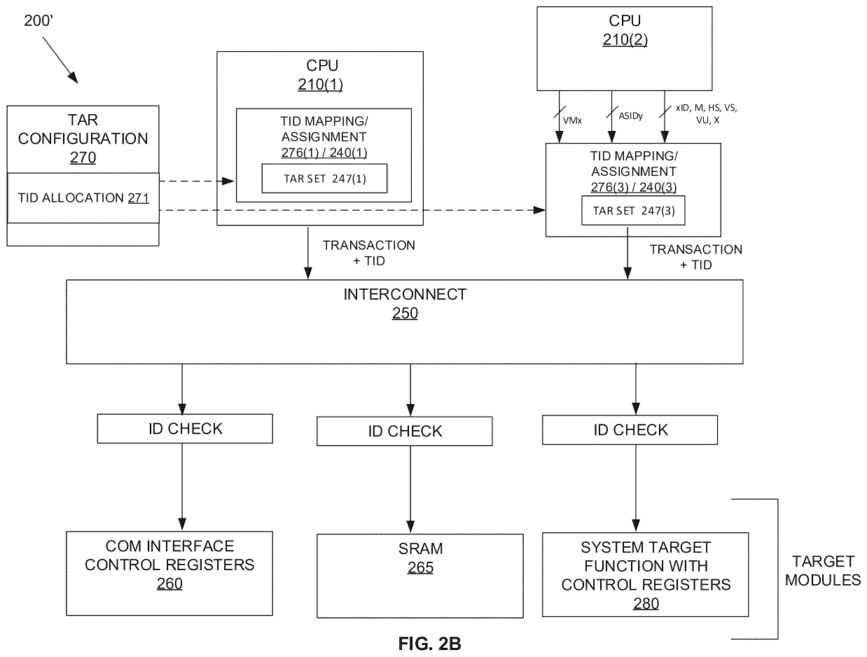

FIG. 2A is a block diagram of an example MCU 200 that uses a transaction ID-based approach to providing isolation between applications. The MCU 200 includes several initiators, one or more target modules, and an interconnect 250 that controls the routing of transactions from the initiators to the target modules. In the illustrated example, the initiators include a CPU 210, Ethernet controller 220, and a system direct media access (DMA) controller 230. Other initiators (not shown) could include CAN XL modules, peripheral component interconnect express (PCIe) modules, xGETH DMA modules, gigabyte Ethernet (GETH) DMA, and so on.

Each initiator includes several sub-modules that may be assigned to different applications. For example the CPU 210 may have sub-modules (e.g., groups of hardware components) that correspond to different privilege modes, virtual machines, operating systems, and so on, each which may be assigned to support different applications/application sub-tasks. As shown in FIG. 2A, sub-modules or functions of a CPU 210 may be uniquely identified by certain address-phase attribute values that are included in the transaction (e.g., VM, ASID, M, HS, VS, VU, XID). XID refers generally to a proprietary or future initiator function identifier. The transaction includes an opcode X that identifies a particular access request to a particular target module. Similarly, application sub-tasks generated by the Ethernet controller 220 may be identified by a particular ETH DMA channel and application sub-tasks generated by the system DMA controller may be identified by a particular system DMA channel.

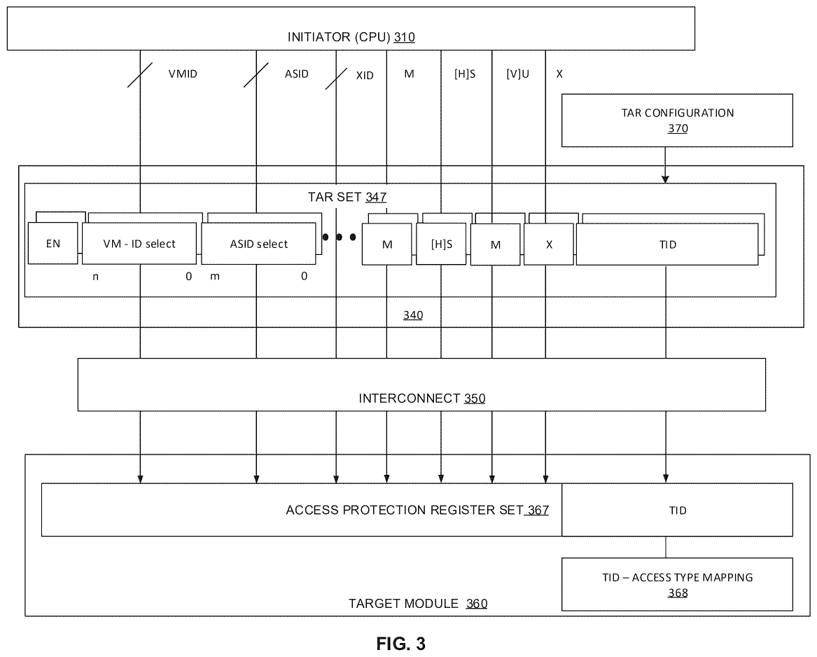

As will be described in more detail with reference to FIG. 3, transaction identifier (TID) circuitry 240 may be associated with each initiator. The TID circuitry 240 includes a TID assignment register (TAR) set 247 that maps TIDs to one or more specific application sub-tasks associated with the particular combination of address phase attribute values. Based on the TAR registers and the address phase attribute values, the TID circuitry 240 appends a TID to each transaction generated by the initiator.

Target modules are associated with shared resources or services and, in the illustrated example, include component object model (COM) interface control registers 260, a static random access memory (SRAM) 265, and system target function with control registers 280. TIDs are mapped, at the target modules, to level or type of read and/or write access (e.g., read only, write only, read and write, neither read nor write). Different TIDs that are mapped to the same read/write access are used in order to support configurable isolation as between initiator sub-modules and functions, applications, tasks, and so on. This highly granular approach may be useful for isolation in the case of mixed criticality as between different applications and within applications.

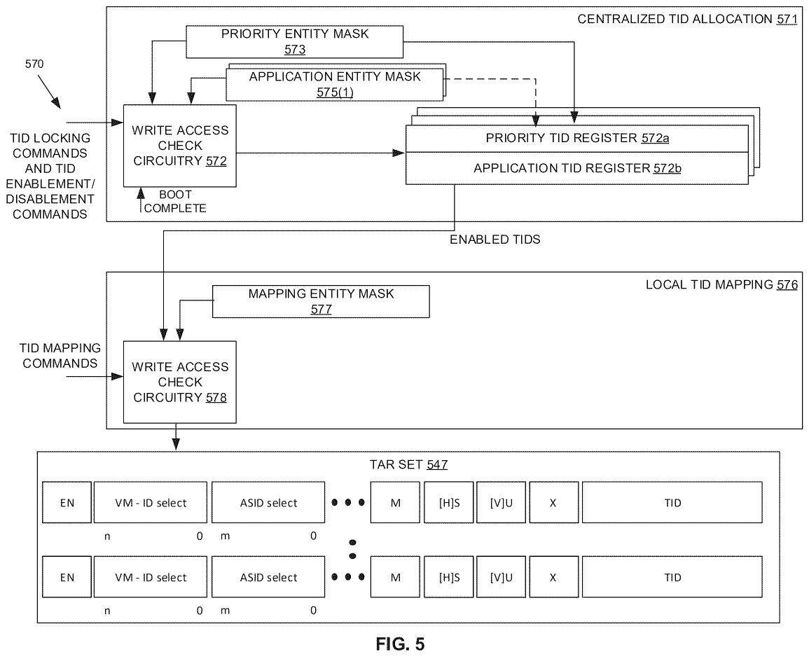

At each boot of the MCU 200, the TAR sets 247 are populated to define a mapping of TIDs to one or more specific application sub-tasks associated with the particular combination of address phase attribute values. This configuration of the TAR register sets 247 is performed by TAR configuration circuitry 270. As will be described in more detail with reference to FIGS. 5 and 5, the TAR configuration circuitry 270 includes TID allocation circuitry 271 which locks or disables certain TIDs for use by any application in execution on the initiator and enables/disables other TIDs for optional use by a given application in execution on the initiator. The TAR configuration circuitry 270 also includes TID mapping circuitry 276 that populates the TAR registers 247 based on the locking and disablement/enablement of certain TIDs by the TID allocation circuitry 271. In the example illustrated in FIG. 2A, the TAR configuration circuitry 270 is centralized and implemented in hardware that is not part of any initiator.

FIG. 2B is a block diagram of another example MCU 200′ in which the TID mapping circuitry 276 is not centralized as in FIG. 2A. For example, CPU 210(1) includes both TID mapping circuitry 276(1) and TID assignment circuitry 240(1). In this example, the CPU does not provide ASID, VMID, and other transaction attributes to an external TID assignment module, but rather the locked/enabled/disabled TIDs received from the TID allocation circuitry 271 are assigned to the privilege state of the CPU. This is done via CPU internal control registers where a higher privilege CPU state assigns the TIDs to the next lower privilege state(s) before the next software task with a lower privilege state is started. CPU 210(2) provides transactions having transaction attribute values to a local TID mapping circuitry 276(2) and TID assignment circuitry 240(2) that receives locked/disabled/enabled TIDs from TID allocation circuitry 271 and populates the TAR set 247(2) to map the transaction attribute values to TIDs.

FIG. 3 illustrates an example TID assignment process for a CPU type initiator 310 that includes TID circuitry 340 that appends a TID to each transaction that is being provided to the interconnect. In some examples, each initiator includes dedicated TID circuitry 340 and in other examples, centralized TID circuitry may append TIDs to transactions from multiple initiators. Transactions generated by the initiator 310 include address phase attribute values for VMID, ASID, XID, M, [H]S, [V]U, as well as an opcode X. The TID circuitry 340 includes a TAR set 347 that includes a register for each possible TID value. Each TID assignment register (TAR) is configured to store a set of address phase attribute values corresponding to an initiator sub module or function and bits that encode a TID value. When a transaction is received by the TID circuitry 340 the circuitry 340 identifies a TAR that holds the matching transaction attribute values. The TID stored in the identified TAR is appended to the transaction and provided along with the transaction to an interconnect 350.

A target module 360 includes an access protection register set 367 that includes an access protection register for each possible TID value. The target module includes TID-to-access type mapping circuitry 368 that maps a type of access to each TID. The target module 360 controls access to its hardware and/or services based on a TID included in a transaction and the mapping provided by the TID-to-access type mapping circuitry 368.

TAR configuration circuitry 370 populates the contents of each TAR in the set 347 during an initial configuration process which may occur upon each boot of the MCU. As will be discussed in more detail below, mechanisms may be provided to reserve certain TIDs for priority applications and to prevent customer applications from being assigned a reserved TID.

In a multi-core CPU, a general distinction is typically made between two types of applications, referred to herein as priority applications and customer applications. Priority applications have special protections requirements and require functional isolation from the customer applications. Priority applications may be based on MCU manufacturer software and may be started during the firmware or boot phase and remain under control of the MCU manufacturer software throughout the MCU runtime. Priority applications may offer functions to customer applications via software interfaces and can be extended with customer software tasks. Priority applications may require functional isolation from each other so that they do not rely on each other and also functional isolation from customer applications that will be started later after the successful execution of the boot phase.

Examples of priority applications include a secure application that performs the secure boot. This application may be executed by a dedicated CPU with separate memory and dedicated targets which are still used for the secure application during runtime. Another priority application is a safety application that performs the safe boot. This application may be executed on a dedicated CPU with separate memory and dedicated targets which are still used for the safety application during runtime, for example, for handling safety relevant alarm signals, power and MCU status control and as a stand-by controller.

Customer applications may start after successful completion of the boot phase on the designated initiators, target modules, and system memory areas. To execute customer applications, customers combine initiators and target modules as well as system memory areas into functional groups and functionally isolate the functional groups from each other with the support of system access protection and its transaction IDs as will be discussed below. The functional groups can initially be defined by customer startup software via the system access protection by assigning transactions IDs or groups of transaction IDs to the initiators and configuring the access control for the target modules. The customer applications should be enabled to configure the multiple customer applications amongst themselves, for example the customer applications should be enabled to assign transaction IDs and groups of transaction IDs to their initiators and secure their target modules via configuration of access protection.

Disclosed herein are hierarchical access protection configuration systems, methods, and circuitries that allow authorized priority entities to prevent customer applications from assigning certain TIDs to customer application tasks. In this manner, TIDs may be permanently reserved (e.g., until a next MCU reset) for use by priority applications that are trusted by the MCU.

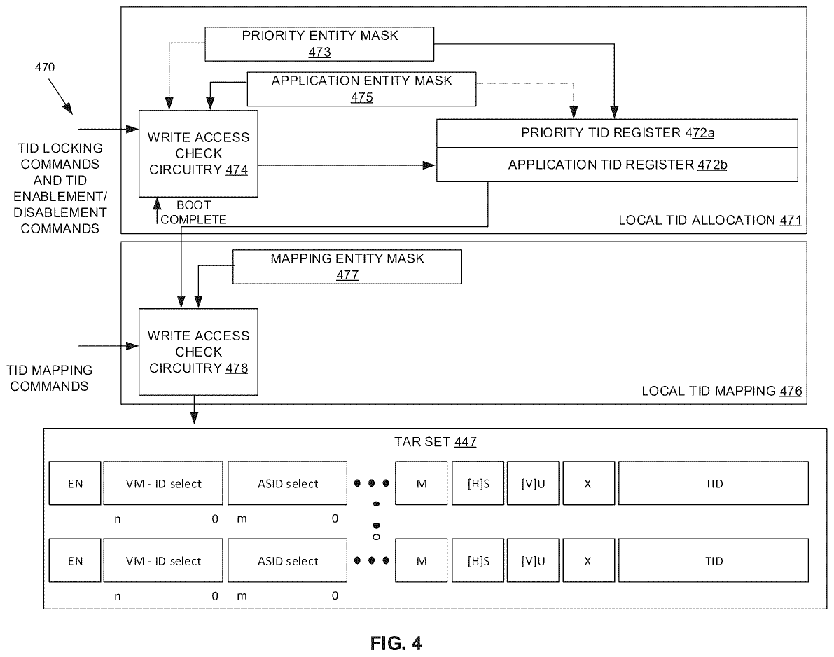

FIG. 4 illustrates an example TID configuration circuitry 470. In the example illustrated in FIG. 4, an initiator in an MCU includes local TID allocation circuitry 471 and local TID mapping circuitry 476 implemented in the initiator. The example TID configuration circuitry 470 is configured for use with a CPU type initiator. The TID configuration circuitry 470 populates register contents of a TAR set 447 subject to constraints on TIDs for the initiator.

The TIDS that are enabled for each application, or group of application sub-tasks that are to be isolated, in execution by an initiator are defined by the contents of a pair of TID registers 472 that each include a bit for each possible TID. For example, if a TID has 7 bits, each TID register will store 2⁷ or 128 bits, each bit corresponding to a different TID. A priority TID register 472a includes a locking feature that locks the disabled status of individual bit values until a next MCU reset. For example, upon MCU boot or reset, the values of the priority TID register 472a may reset to a value that enables use of the mapped TID (e.g., a bit value of 1). The priority TID register 472a may include a locking feature that does not allow a bit value of 0 to be re-set to 1. In this manner once the value of a bit in the priority TID register 472a is changed to 0 to disable use of the corresponding TID by an application, the bit value may not be changed to allow use of the locked TID by the application until the next MCU reset. Other locking features may be used to prevent the changing of a bit value in the priority TID register until a next MCU reset. An application TID register 472b stores an enabled/disabled status for each TID that has not already been locked/disabled in the priority TID register 472a.

The contents of the TID registers 472 are set in a hierarchical manner that allows authorized priority entities, such as priority applications, to permanently reserve TIDs as follows. Two masks are defined that are used to screen write access transactions that seek to write one or more bit values to the TID registers 472. A priority entity mask 473 identifies one or more priority initiators (e.g., trusted boot CPUs) that are authorized to permanently reserve TIDs by setting (and locking) bits in the priority TID register to prevent use of corresponding TIDs by any other entity. An application entity mask 475 identifies initiator sub-modules or functions (e.g., by way of a combination of address phase attributes such as VMID, ASID, and so on) that are authorized to enable and disable bits in the application TID register 472b to enable/disable certain TIDs for use by an application in execution by the initiator.

In a first phase of TID register configuration, first write access check circuitry 474 prevents write access to the priority TID register 472a by initiator sub modules or functions that are not identified as authorized priority entities the priority entity mask 473. The write transactions that set bits in the priority TID register to disabled status may be referred to herein as locking commands. The first phase may coincide with an MCU boot phase and the priority entities may include one or more trusted boot CPUs operating in their highest privilege mode. At the end of the first phase the bit values that have been set in the priority TID register 472a to disable use of the corresponding TIDs are locked to prevent changing of the bit values until the next MCU reset. The bit values in the priority TID register 472a may be locked by way of a command or action from an authorized priority initiator function (as defined by the priority initiator mask). The set bit values may be locked due to an inherent feature of the TID register 472 as discussed above. The values of the bits in the priority TID register 472a may be locked at the end of the boot phase. In this manner, an authorized priority entity may set values in priority TID register 472a to permanently prevent any application from using certain TIDs. Recall that examples of priority applications include secure applications and safety applications. Priority initiator functions are associated with priority applications.

In a second configuration phase, which may occur after completion of the boot phase, the first write access check circuitry 474 allows write requests, also called TID enablement/disablement commands, from authorized application entities, such as customer applications, that are defined in the application entity mask 475. The first write access check circuitry 474 may be triggered to enter the second configuration phase by receiving an indication that the boot has successfully completed. During this phase, authorized application entities, such as customer applications or application sub-tasks, that are allowed by the application entity mask 475 set bits in the application TID register 472b to enable or disable corresponding TIDs for use by the application, subject to the reserved TIDs that were locked in the first phase. For example, the authorized application entities that are allowed by the mask 475 may set bits corresponding to any TID to an enabled status except bits corresponding to TIDs disabled in the priority TID register 472a.

At the end of the second phase, the bit values in the application TID register 472b may be locked by the locking feature 479. The locking may be accomplished by way of a command or action from an authorized application entity. The bit values may be locked due to an inherent feature of the application TID register 472b as disclosed above. This locking of bits in the TID register 472 after the second phase prevents the addition or subtraction of allocated TIDs with respect to the application. In other examples, the application TID register bit values may not be locked so that the TID allocation for the application may be changed during runtime to enhance flexibility.

At the end of the second configuration phase, the application TID register 472b identifies a set of TIDs that may be used by the application in execution on the initiator and also identifies a set of TIDs that are disabled for use by the application. The enabled TIDs in the set are mapped to application sub-modules or functions in a third configuration phase. A mapping entity mask 477 defines authorized mapping entities, such as initiator sub-modules or functions that are authorized to map TIDs to the application's sub-tasks. Second write access check circuitry 478 screens write transactions based on the mapping entity mask 477 and the TID registers 472. The write transactions populate the TARs 447, thereby mapping application sub-tasks to TIDs. In this manner, the second write access check circuitry 478 screens write transactions to the TAR set 447 based on whether the entity, such as an initiator sub-module or function that is the source of the write transaction, is identified in the mapping entity mask 477 and also based on whether the TID being written to the TAR is enabled for use by the application in the TID registers 472. It is noted that the contents of the TARs may be changed during runtime in some examples to provide flexibility.

FIG. 5 illustrates an example TID configuration circuitry 570. In the example illustrated in FIG. 5, centralized TID allocation circuitry 571 is implemented external to an initiator hosting applications being configured with TIDs, such as in an interconnect. Local TID mapping circuitry 576 is implemented at each initiator. The example TID configuration circuitry 570 is configured for use with a CPU type initiator. The TID configuration circuitry 570 populates register contents of a TAR set 547 subject to constraints on TIDs for the initiator.

The enabled TIDS for each application, or group of application sub-tasks that are to be isolated, in execution by an initiator are defined in a pair of TID registers 572 that each includes a bit for each possible TID. For example, if a TID has 7 bits, each TID register will store 2⁷ or 128 bits, each bit corresponding to a different TID. A priority TID register 572a includes a locking feature that locks the disabled status of individual bit values until a next MCU reset. For example, upon MCU boot or reset, the values of the priority TID register 572a may reset to a value that enables use of the mapped TID (e.g., a bit value of 1). The priority TID register 572a may include a locking feature that does not allow a bit value of 0 to be set to 1. In this manner once the value of a bit in the priority TID register 572a is changed to 0 to disable use of the corresponding TID by an application, the bit value may not be changed to allow use of the locked TID by the application until the next MCU reset. Other locking features may be used to prevent the changing of a bit value in the priority TID register until a next MCU reset. An application TID register 572b stores an enabled/disabled status for each TID that has not already been locked/disabled in the priority TID register 572a.

The contents of the TID registers 572 are set in a hierarchical manner that allows authorized priority entities, such as priority applications, to permanently reserve TIDs as follows. Two masks are defined that are used to screen write access transactions that seek to write one or more bit values to the TID registers 572. A priority entity mask 573 identifies one or more priority initiators (e.g., trusted boot CPUs) that are authorized to permanently reserve TIDs by setting bits in the priority TID register to prevent use of corresponding TIDs by any other entity. An application entity mask 575 identifies initiator sub-modules or functions (e.g., by way of a combination of address phase attributes such as VMID, ASID, and so on) that are authorized to enable and disable bits in the application TID register 572b to enable or disable certain TIDs for use by an application in execution by the initiator.

In a first phase of TID register configuration, first write access check circuitry 574 prevents write access to the priority TID register 572a by initiator sub modules or functions that are not identified as authorized priority entities the priority entity mask 573. The write transactions that set bits in the priority TID register 572a to disabled status may be referred to herein as locking commands. The first phase may coincide with an MCU boot phase and the priority entities may include one or more trusted boot CPUs operating in their highest privilege mode. At the end of the first phase the bit values that have been set in the priority TID register 572a to disable use of the corresponding TIDs are locked to prevent changing of the bit values until the next MCU reset. The bit values in the priority TID register 572a may be locked by way of a command or action from an authorized priority initiator function (as defined by the priority initiator mask). The bit values may be locked due to an inherent feature of the TID register 572 as disclosed above. The values of the bits in the priority TID register 572a may be locked at the end of the boot phase. In this manner, an authorized priority entity may set values in priority TID register 572a to permanently prevent the application from using certain TIDs.

In a second configuration phase, which may occur after completion of the boot phase, the first write access check circuitry 574 allows write requests, also called TID enablement/disablement commands, from authorized application entities, such as customer applications, that are defined in the application entity mask 575. The first write access check circuitry 574 may be triggered to enter the second configuration phase by receiving an indication that the boot has successfully completed. During this phase, authorized application entities, such as customer applications or application sub-tasks, that are allowed by the application entity mask 575 set bits in the application TID register 572b to enable or disable corresponding TIDs for use by the application, subject to the reserved TIDs that were locked in the first phase. For example, the authorized application entities that are allowed by the application entity mask 575 may set bits corresponding to any TID to an enabled status except bits corresponding to TIDs disabled in the priority TID register 572a.

At the end of the second phase, the bit values in the application TID register 572b may be locked by the locking feature 579. The locking may be accomplished by way of a command or action from an authorized application entity. The bit values may be locked due to an inherent feature of the application TID register 572b as disclosed above. This locking of bits in the application TID register 572b after the second phase prevents the addition or subtraction of allocated TIDs with respect to the application. In other examples, the application TID register bit values may not be locked so that the TID allocation for the application may be changed during runtime to enhance flexibility.

At the end of the second configuration phase, the application TID register 572b identifies a set of TIDs that may be used by the application in execution on the initiator and also identifies a set of TIDs that are disabled for use by the application. The enabled TIDs are mapped to application sub-modules or functions in a third configuration phase. Enabled TIDs are communicated to local TID mapping circuitry 576 on an initiator that hosts the application being configured. For example, the local TID mapping circuitry 576 may be able to read (but not write to) the application TID register 572b for the application.

A mapping entity mask 577 defines authorized mapping entities, such as initiator sub-modules or functions that are authorized to map TIDs to the application's sub-tasks. Second write access check circuitry 578 screens write transactions based on the mapping entity mask 577 and the TID registers 572. The write transactions populate the TARs 547, thereby mapping application sub-tasks to TIDs. In this manner, the second write access check circuitry 578 screens write transactions to the TAR set 547 based on whether the entity, such as an initiator sub-module or function that is the source of the write transaction, is identified in the mapping entity mask 577 and also based on whether the TID being written to the TAR is enabled for use by the application in the TID registers 572. It is noted that the contents of the TARs may be changed during runtime in some examples to provide flexibility.

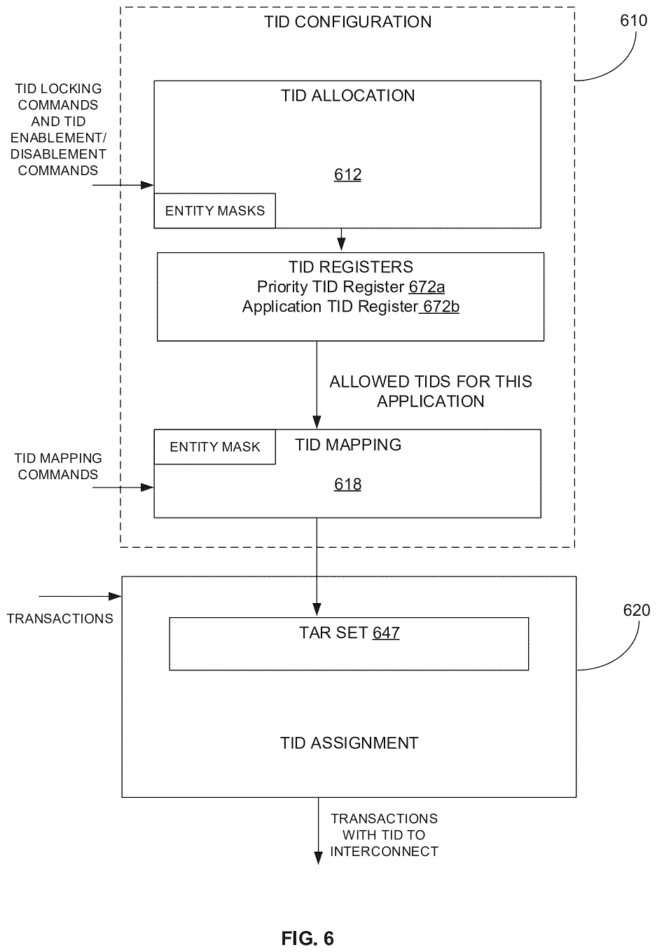

FIG. 6 is a flow diagram outlining an example method for securely allocating and assigning transaction identifiers to transactions that access shared resources. The method includes two main phases, TID configuration 610 and TID assignment 620. The TID configuration phase 610 may occur upon reset of a microcontroller while the TID assignment phase 620 occurs during operation of the microcontroller in which one or more initiators generates transactions accessing shared resources (e.g., target modules of FIG. 1).

At 612 TIDs are allocated to one or more applications of an initiator using a priority TID register 672a and an application TID register 672b. The TID registers 672a, 672b, each have a bit corresponding to each possible TID and each bit can be set to an enabled status (allowed for use by an application) or a disabled status (not allowed for use by an application). Upon microcontroller reset, TID locking commands from priority entities are processed. The priority entities are screened based on a priority entity mask as described above. The TID locking commands set bits in a priority TID register 672a to a disabled status. The disabled status of bits in the priority TID register 672a is locked, for example, until a next reset of the microcontroller.

After the bit values of the priority TID register 672a has been set, TID enablement/disablement commands from application entities are processed. The application entities are screened based on an application entity mask as described above. The TID enablement/disablement commands set bits in an application TID register 672b to an enabled or disabled status. Any bit in the application TID register that corresponds to a TID that is disabled in the priority TID register 672a (e.g., having a corresponding bit in the priority TID register 672a with a disabled status) may not be enabled for use by an enablement command from an application entity. After the TID allocation 612, a set of allowed or enabled TIDs for a given application (as defined in the application TID register 672b) has been established. After the initial TID allocation by application entities, the content of the application TID register 672b may be locked. Alternatively, application entities may be allowed to change the enabled/disabled status of bits in the application TID register at other times, subject to the permanent disablement of certain TIDs as defined in the priority TID register.

At 618, the enabled TIDs for a given application are mapped to application sub-tasks. This may be performed by processing TID mapping commands from mapping entities. The mapping entities are screened based on a mapping entity mask as described above. The TID mapping commands populate the contents of a set of TAR registers 647. Each TAR register stores an enabled TID and a unique set of transaction attribute values that identifies an application sub-task as shown in FIGS. 3, 4, and 5.

During the TID assignment phase 620, transactions each having a corresponding set of transaction attribute values are appended with a mapped TID based on the TAR set 647. The transactions with a TID are provided to the interconnect.

It can be seen from the foregoing description that the disclosed systems, methods, and circuitries support hierarchical allocation of transaction identifiers to enable priority applications to permanently reserve transaction identifiers and prevent customer applications from assigning the reserved transaction identifiers.

In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Examples can include subject matter such as a method, means for performing acts or blocks of the method, at least one machine-readable medium including instructions that, when performed by a machine cause the machine to perform operations according to embodiments and examples described herein.

### Examples

Example 1 is a controller, including at least one target module; one or more initiators coupled to the at least one target module by an interconnect, the one or more initiators configured to generate transactions seeking access to a target module, wherein each transaction is associated with an application sub-task in execution on a respective initiator; and transaction identifier (TID) allocation circuitry. The TID allocation circuitry is configured to process TID locking commands from one or more priority entities, wherein the locking commands disable TIDs in a first set of TIDs, wherein a disabled status of the TIDs of the first set of TIDs is locked until a next controller reset, and process TID enablement/disablement commands from one or more application entities, wherein each application entity is associated with an initiator, further wherein the enablement/disablement commands enable or disable one or more TIDs for use by the associated initiator subject to the constraint that the TIDs in the first set of TIDs cannot be enabled for use by an enablement command.

Example 2 includes the subject matter of example 1, including or omitting optional elements, further including TID assignment circuitry configured to based on an application sub-task associated with a transaction generated by the associated initiator, append a mapped TID to the transaction; and provide the transaction and the appended TID to the interconnect.

Example 3 includes the subject matter of example 1, including or omitting optional elements, further including TID mapping circuitry configured to process TID mapping commands from one or more mapping entities; and based on the TID mapping commands, map respective enabled TIDs to application sub-tasks in execution on the associated initiator, wherein each TID is mapped to a type of read and/or write access in one or more of the at least one target module.

Example 4 includes the subject matter of example 3, including or omitting optional elements, wherein respective TID mapping circuitries are implemented in respective initiators of the one or more initiators.

Example 5 includes the subject matter of example 3, including or omitting optional elements, wherein the TID mapping circuitry is implemented external to the one or more initiators.

Example 6 includes the subject matter of example 3, including or omitting optional elements, wherein the TID mapping circuitry is configured to reject TID mapping commands received from entities not identified as mapping entities.

Example 7 includes the subject matter of example 1, including or omitting optional elements, wherein the TID locking commands are received during a boot phase of the controller.

Example 8 includes the subject matter of example 1, including or omitting optional elements, wherein the TID enablement/disablement commands are received after a boot phase of the controller.

Example 9 includes the subject matter of example 1, including or omitting optional elements, wherein the TID allocation circuitry is configured to reject TID locking commands received from entities not identified as priority entities.

Example 10 includes the subject matter of example 1, including or omitting optional elements, wherein the TID allocation circuitry is configured to reject TID enablement/disablement commands received from entities not identified as application entities.

Example 11 includes the subject matter of example 1, including or omitting optional elements, wherein the priority entities and the application entities are independently configured by a priority entity.

Example 12 includes the subject matter of example 1, including or omitting optional elements, wherein respective TID allocation circuitries are implemented in respective initiators.

Example 13 includes the subject matter of example 1, including or omitting optional elements, wherein the TID allocation circuitry is implemented external to the one or more initiators.

Example 14 is transaction identifier (TID) allocation circuitry, including a priority entity mask that defines one or more priority entities authorized to permanently disable TIDs from a set of TIDs, wherein a TID disabled by the priority entities cannot be used by any application; an application entity mask that defines one or more application entities authorized to enable and disable TIDs for use by an application; a priority TID register that includes a bit corresponding to each TID in the set of TIDs, wherein the priority TID register includes a locking feature that locks a disabled status of selected bits until a next controller reset, wherein access for setting an enabled or disabled status of the bits the priority TID register is limited to entities defined in the priority entity mask; and an application TID register that includes a bit corresponding to each TID in the set of TIDs, wherein access for setting an enabled or disabled status of the bits the application TID register is limited to entities defined in the application entity mask, further wherein bits in the application TID register corresponding to TIDs that are disabled in the priority TID register cannot be set to an enabled status.

Example 15 includes the subject matter of example 14, including or omitting optional elements, further including write access check circuitry configured to process, based on the priority entity mask, TID locking commands that set bits in the priority TID register to a disabled status; and process, based on the application entity mask and the priority TID register, enablement/disablement commands that set bits in the application TID register to an enabled or disabled status.

Example 16 includes the subject matter of example 15, including or omitting optional elements, wherein the write access check circuitry is configured to reject TID locking commands received from entities not identified as priority entities.

Example 17 includes the subject matter of example 15, including or omitting optional elements, wherein the write access check circuitry is configured to reject TID enablement/disablement commands received from entities not identified as application entities.

Example 18 includes the subject matter of example 14, including or omitting optional elements, wherein an enablement/disablement status of bits in the application TID register is locked until the next controller reset.

Example 19 is TID mapping circuity, including a priority TID register that includes a bit corresponding to each TID in a set of TIDs, wherein the priority TID register includes a locking feature that locks a disabled status of selected bits until a next controller reset; an application TID register that includes a bit corresponding to each TID in the set of TIDs, wherein bits in the application TID register corresponding to TIDs that are disabled in the priority TID register cannot be set to an enabled status; a mapping entity mask that defines one or more entities authorized to map TIDs to sub-tasks of an application; and write access check circuitry configured to process mapping commands that map TIDs to sub-tasks of the application based on the priority TID register, the application TID register, and the mapping entity mask; and populate one or more transaction assignment registers based on the mapping commands.

Example 20 includes the subject matter of example 19, including or omitting optional elements, wherein the write access check circuitry is configured to reject TID mapping commands received from entities not identified as mapping entities in the mapping entity mask.

Various illustrative logics, logical blocks, modules, circuitries, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

In the present disclosure like reference numerals are used to refer to like elements throughout, and wherein the illustrated structures and devices are not necessarily drawn to scale. As utilized herein, terms “module”, “component,” “system,” “circuit,” “circuitry,” “element,” “slice,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein the term “or” includes the option of all elements related by the word or. For example A or B is to be construed as include only A, only B, and both A and B. Further the phrase “one or more of” followed by A, B, or C is to be construed as including A, B, C, AB, AC, BC, and ABC.

What is claimed is:

1. A controller, comprising:
at least one target module;
one or more initiators coupled to the at least one target module by an interconnect, the one or more initiators configured to generate transactions seeking access to a target module, wherein each transaction is associated with an application sub-task in execution on a respective initiator; and
transaction identifier (TID) allocation circuitry, the TID allocation circuitry configured to
process TID locking commands from one or more priority entities, wherein the locking commands disable TIDs in a first set of TIDs, wherein a disabled status of the TIDs of the first set of TIDs is locked until a next controller reset, and
process TID enablement/disablement commands from one or more application entities, wherein each application entity is associated with an initiator, further wherein the enablement/disablement commands enable or disable one or more TIDs for use by the associated initiator subject to the constraint that the TIDs in the first set of TIDs cannot be enabled for use by an enablement command.

2. The controller of claim 1, further comprising TID assignment circuitry configured to
based on an application sub-task associated with a transaction generated by the associated initiator, append a mapped TID to the transaction; and
provide the transaction and the appended TID to the interconnect.

3. The controller of claim 1, further comprising TID mapping circuitry configured to
process TID mapping commands from one or more mapping entities; and
based on the TID mapping commands, map respective enabled TIDs to application sub-tasks in execution on the associated initiator, wherein each TID is mapped to a type of read and/or write access in one or more of the at least one target module.

4. The controller of claim 3, wherein respective TID mapping circuitries are implemented in respective initiators of the one or more initiators.

5. The controller of claim 3, wherein the TID mapping circuitry is implemented external to the one or more initiators.

6. The controller of claim 3, wherein the TID mapping circuitry is configured to reject TID mapping commands received from entities not identified as mapping entities.

7. The controller of claim 1, wherein the TID locking commands are received during a boot phase of the controller.

8. The controller of claim 1, wherein the TID enablement/disablement commands are received after a boot phase of the controller.

9. The controller of claim 1, wherein the TID allocation circuitry is configured to reject TID locking commands received from entities not identified as priority entities.

10. The controller of claim 1, wherein the TID allocation circuitry is configured to reject TID enablement/disablement commands received from entities not identified as application entities.

11. The controller of claim 1, wherein the priority entities and the application entities are independently configured by a priority entity.

12. The controller of claim 1, wherein respective TID allocation circuitries are implemented in respective initiators.

13. The controller of claim 1, wherein the TID allocation circuitry is implemented external to the one or more initiators.

14. Transaction identifier (TID) allocation circuitry, comprising
a priority entity mask that defines one or more priority entities authorized to permanently disable TIDs from a set of TIDs, wherein a TID disabled by the priority entities cannot be used by any application;
an application entity mask that defines one or more application entities authorized to enable and disable TIDs for use by an application;
a priority TID register that includes a bit corresponding to each TID in the set of TIDs, wherein the priority TID register includes a locking feature that locks a disabled status of selected bits until a next controller reset, wherein access for setting an enabled or disabled status of the bits the priority TID register is limited to entities defined in the priority entity mask; and
an application TID register that includes a bit corresponding to each TID in the set of TIDs, wherein access for setting an enabled or disabled status of the bits the application TID register is limited to entities defined in the application entity mask, further wherein bits in the application TID register corresponding to TIDs that are disabled in the priority TID register cannot be set to an enabled status.

15. The TID allocation circuitry of claim 14, further comprising write access check circuitry configured to
process, based on the priority entity mask, TID locking commands that set bits in the priority TID register to a disabled status; and
process, based on the application entity mask and the priority TID register, enablement/disablement commands that set bits in the application TID register to an enabled or disabled status.

16. The TID allocation circuitry of claim 15, wherein the write access check circuitry is configured to reject TID locking commands received from entities not identified as priority entities.

17. The TID allocation circuitry of claim 15, wherein the write access check circuitry is configured to reject TID enablement/disablement commands received from entities not identified as application entities.

18. The TID allocation circuitry or claim 14, wherein an enablement/disablement status of bits in the application TID register is locked until the next controller reset.

19. TID mapping circuity, comprising:
a priority TID register that includes a bit corresponding to each TID in a set of TIDs, wherein the priority TID register includes a locking feature that locks a disabled status of selected bits until a next controller reset;
an application TID register that includes a bit corresponding to each TID in the set of TIDs, wherein bits in the application TID register corresponding to TIDs that are disabled in the priority TID register cannot be set to an enabled status;
a mapping entity mask that defines one or more entities authorized to map TIDs to sub-tasks of an application; and
write access check circuitry configured to
process mapping commands that map TIDs to sub-tasks of the application based on the priority TID register, the application TID register, and the mapping entity mask; and
populate one or more transaction assignment registers based on the mapping commands.

20. The TID mapping circuitry of claim 19, wherein the write access check circuitry is configured to reject TID mapping commands received from entities not identified as mapping entities in the mapping entity mask.
